(19) United States
(12) Patent Application Publication
(10) Pub. No.: US 2015/0184791 A1
(43) Pub. Date: Jul. 2, 2015

(54) ADJUSTABLE SUPPORT

(71) Applicant: Kenneth H. Chow, Rodeo, CA (US)

(72) Inventor: Kenneth H. Chow, Rodeo, CA (US)

(21) Appl. No.: 14/587,408

(22) Filed: Dec. 31, 2014

Related U.S. Application Data
(60) Provisional application No. 61/923,201, filed on Jan. 2, 2014.
(60) Provisional application No. 61/923,194, filed on Jan. 2, 2014.

(51) Int. Cl. F16M 11/04; F16M 11/20; F16M 11/16

(52) U.S. Cl. CPC F16M 11/043; F16M 11/16; F16M 11/2021

(57) ABSTRACT

A stand for positioning a mobile electronic device with a built-in camera to an object supported on a support surface is shown. The space below the lens of the camera becomes unobstructed by the stand. The position of the mobile electronic device may be raised or lowered. A shelf upon which the mobile electronic device is supported may have through hole that receives a dowel rod. The dowel rod may have a hinged connection at the base. The dowel rod and the through hole may be in frictional engagement to each other for positioning the shelf to the object to be photographed or imaged. In order to raise or lower the shelf, the frictional engagement between the through hole of the shelf and the dowel rod may be disengaged then when the proper vertical position of the shelf is achieved, frictional engagement therebetween is reestablished. In order to adjust the level of the shelf, the angle established by the hinged connection may be changed by hand without the use of separate tools.

### CROSS-REFERENCE TO RELATED APPLICATIONS

This application claims the benefits of Provisional Patent Application Ser. Nos. 61/923,194 and 61/923,201, filed on Jan. 2, 2014, the entire contents of which are expressly incorporated herein by reference.

### STATEMENT RE: FEDERALLY SPONSORED RESEARCH/DEVELOPMENT

Not Applicable

### BACKGROUND

Various embodiments and aspects described herein relate to a stand for positioning a mobile electronic device with a built-in camera to an object being imaged or photographed.

Camera equipped computers and phones are fast growing in use. IPhones, iPads, Samsung Galaxies and similar mobile electronic devices that have built in cameras are often used to perform hand held close up photography by manually holding the device as stable as possible while trying to shoot the straightest, clearest, sharpest picture. Often it is tiring and problematic and produces inconsistent results.

Prior art stands, tripods, and props do not provide parallel planes between the mobile device and the target artwork. Those that may provide parallel planes are not adjustable for height, have the encumbrance of an obstructed view from the camera, or just very expensive, bulky and heavy. If the camera is skewed (i.e., not parallel) with respect to the target artwork, the target artwork may have a diminishing perspective view which may be undesirable. Additionally, both hands are often preoccupied in holding the camera-equipped device as motionless as possible in trying to avoid blurred images. Often times, it is also necessary to hold the target artwork in position with the other hand.

Accordingly, there is a need in the art for an improved stand.

### BRIEF SUMMARY

A stand for positioning a mobile electronic device that has a built-in camera with respect to support surface is shown. The stand includes a shelf upon which the mobile electronic device rests upon when it is imaging such as taking a photograph. The shelf and consequently the mobile electronic device may be slidably positioned on a dowel rod to move the mobile electronic device further away or closer to an object to be photographed that is placed on the support surface below. Regardless of the vertical position, the angular relationship between the shelf and support surface is the same or can be readjusted. The shelf is adjustably positioned along the length of the dowel rod by way of a loose, slidable cantilever, namely, friction engagement between the dowel rod and a through hole of the shelf. The shelf 12 may be moved up and down to any position merely by releasing frictional engagement between the dowel rod and the through hole of the shelf, moving the shelf up and down then releasing the shelf to reestablish frictional engagement between the through hole and the dowel rod. When the electronic mobile device is placed on the shelf, the camera of the electronic mobile device has an unobstructed view to the object being photographed.

More particularly, a stand for holding a mobile electronic device with a built-in camera above a support surface at a particular angle to provide unobstructed clearance below to the support surface is disclosed. The stand may include a shelf, a dowel rod and a base. The shelf may be capable of holding the mobile electronic device with the camera pointed downward. The shelf may have an angled through hole formed away from a center of mass of the shelf. The dowel rod may be extended through and slid into the angled through hole. The dowel rod may be frictionally engaged to the angled through hole when the dowel rod is skewed with respect to a vertical axis. The shelf may pivot about the angled through hole so that opposed interior surfaces of the angled through hole frictionally engage the dowel rod to prevent downward sliding of the shelf on the dowel rod, producing a leveraged or cantilevered shelf. The base may be attached to the dowel rod below the shelf. The base may be sufficient to hold the dowel rod and the shelf in a stationary position with respect to the support surface.

The base and the dowel rod may be fixedly attached to each other at a skewed angle so that an upper surface of the shelf upon which the mobile electronic device rests during use is parallel to the support surface or at some other angle (e.g., ±30°).

The base and the dowel rod may be adjustably attached to each other so that an upper surface of the shelf upon which the mobile electronic device rests during use can be corrected for horizontal or for parallel to the support surface below or to some other angle.

The base may be a flat rigid member that extends below the shelf. An object to be photographed may be placed over the flat rigid member during use (i.e., when the photograph is being taken with the camera of the mobile electronic device). The base may be a mounting member that is boltable to the support surface or clampable to the support surface.

The base may be a hinged anchor assembly where the hinge is the link between the dowel rod and an anchor. The anchor may be a mountable member that is boltable or clampable to the support surface. The adjustment of the dowel rod angle and associated shelf angle may be accomplished by adjusting the hinge position or rotational movement. Adjustments may be done by hand that precludes the use of separate tools.

The shelf may have a cut out at a periphery or interior of the shelf to accommodate a camera lens of the mobile electronic device.

The dowel rod may have a round exterior surface and the angled through hole may have a corresponding round interior surface. The inner diameter of the angled through hole may be greater than an outer diameter of the dowel rod.

The dowel rod may have a round, square, triangular, polygonal, I-beam, or T-shaped cross sectional configuration.

The through hole in the shelf may have a corresponding round, square, triangular, polygonal, I-beam or T-shaped cross sectional configuration.

The angled through hole may be formed with an upper lip extending upward at an outer upper edge of the through hole and a lower lip extending downward at an inner lower edge of the through hole.

The through hole in the shelf may be a hole slightly larger than the dowel rod and may be created at a thickened or reinforced portion of the shelf.

The hinged base anchor may be comprised of a friction hinge assembly. The friction hinge may have multiple prongs, each with sufficiently large surface contact area for adequate friction between the prongs. The hinge may have a hand knob threaded onto an axle bolt that compresses the prongs together to restrict the movement or rotational position of the hinge, thereby fixing the angle of the dowel rod and the associated angle of the cantilevered shelf.

The hinged base anchor may instead be comprised of a hinge with one leaf clampable or boltable to the support surface and the other leaf attached to the dowel rod. One leaf of this hinge may have a threaded spindle or bolt with a knob or wheel where turning the knob of wheel adjusts the position of leaf in relation to each other, thereby adjusting the angle of the dowel rod and the associated level of the shelf. Alternatively, one leaf of this hinge may have an attached traversing arm that can be tightened to fix it to the dowel rod, where loosening, repositioning, and retightening of the traversing arm would adjust the angle of the dowel rod and associated level of the shelf.

In another aspect, a method of operating a camera stand of a mobile electronic device above a support surface is disclosed. The method may include the steps of placing the mobile electronic device on an upper surface of a shelf of the camera stand; lifting a shelf of the camera stand upward to disengage frictional engagement between a through hole of the shelf and a dowel rod; traversing the shelf up or down the dowel rod; and tilting the shelf of the camera stand downward to engage frictional engagement between the through hole of the shelf and the dowel rod in a particular position of cantilever, and adjusting the angular level of the shelf.

In the method, the placing step may include the step of engaging the mobile electronic device with a nub or recess formed in the upper surface of the shelf to fix a position of the camera on the shelf.

The lifting step may include the step of releasing an edge of a lower lip of the shelf with the dowel rod. The lifting step may further include the step of releasing an edge of an upper lip of the shelf with the dowel rod.

The tilting step may further comprise the step of releasing the shelf to allow gravity to tilt the shelf downward or to allow manual pushing of the shelf downwards.

The shelf leveling step may include adjusting the angle of the dowel rod. This step may include the turning of a knob or wheel to adjust the rotational position of the hinge at the base, thereby setting a new angle for the dowel rod and the associated shelf. Alternatively, this step may include the loosening of an attached traversing arm on the dowel rod or the loosening of a hinge axis knob to allow free movement of the hinge. This step may subsequently include the retightening of hardware to fix a traversing arm on the dowel rod or the retightening of a hinge axle knob to fix the movement of the hinge, thereby setting a new angle for the dowel rod and correcting for the level of the shelf. This repositioning of the dowel rod angle compensates for any deflection in the dowel rod or free play in the upper components that renders the mobile electronic device to sit off horizontal, off parallel to support surface, or off any desired angle.

The side-to-side leveling step may include the step of rotationally nudging the shelf about the dowel rod axis for yaw angle compensation. This fine-tuning step is available only in round cross section dowel rod and round through hole.

In another aspect, a stand for adjusting vertical placement of an object above a support surface is disclosed. The stand may comprise a dowel rod, a mounting bracket and an object. The dowel rod may be fixed at a skewed angle with respect to a vertical gravitational direction. The mounting bracket may have a through hole. The through hole may be sufficiently larger than the dowel rod so that the mounting bracket is freely traversable up and down the dowel rod by hand. A lower interior edge of the through hole of the mounting bracket may be frictionally engaged to an outer surface of the dowel rod to fix a position of the mounting bracket on the dowel rod. The object may be attached to the mounting bracket.

The through hole of the mounting bracket may have a central axis generally coaxially aligned to a central axis of the dowel rod when the mounting bracket is freely traversable up and down the dowel rod. The object may be properly aligned to the support surface when the lower interior edge of the through hole of the mounting bracket is frictionally engaged to the exterior surface of the dowel rod, creating a particular position of cantilever in the mounting bracket when it is weighted by an object.

The through hole of the mounting bracket may be defined by an upper lip disposed on an exterior side of the through hole and a lower lip disposed on an interior side of the through hole.

The through hole of the mounting bracket may be created at a thickened or reinforced portion of the mounting bracket.

The object may be a basket. Alternatively, the object may be a camera. Alternatively, the object may be a visual display, illumination device, or whimsical toy.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is perspective view of a fixed-angle stand for supporting a mobile electronic device above an object supported on a support surface;

FIG. 2 is an enlarged perspective view of a through hole of a shelf of the stand;

FIG. 3 is an enlarged perspective view of the through hole and a dowel rod slidingly received into the through hole of the shelf;

FIG. 4 is a side view of the shelf and the dowel rod shown in FIG. 3;

FIG. 5 illustrates the shelf being lifted up to frictionally disengage the dowel rod from the through hole of the shelf;

FIG. 6 illustrates the shelf being moved upward;

FIG. 7 is a perspective view of a first embodiment of a mechanism for providing rotational adjustment to the dowel rod with respect to the support surface;

FIG. 8 illustrates a first means for attaching the stand to the support surface;

FIG. 9 is a second means for attaching the stand to the support surface;

FIG. 10 illustrates a second embodiment of a mechanism for providing for an angular adjustment between the dowel rod and the support surface;

FIG. 11 illustrates bending of a dowel rod and angular adjustment through an adjustable hinge for proper angular positioning of a shelf to a support surface;

FIG. 12 illustrates an alternate use for the stand; and

FIG. 13 illustrates a further alternate use for the stand.

### DETAILED DESCRIPTION

A stand 10 for holding a mobile electronic device 12 having a camera 14 above a support surface 16 at a particular angle 18 is shown. Moreover, a shelf 20 of the stand 10 may be vertically adjusted up 21 or down 22 to bring the camera 14 of the mobile electronic device 12 closer to or further away from an object 24 to be photographed. Regardless of the actual height of the shelf 20 above the support surface 16, the angle 18 can remain the same due to predetermined deflection. In this manner, the angular relationship between the camera 14 of the electronic device 12 and the target object 24 remains the same within a predetermined range of distances between the camera 14 of the electronic device and the target object 24. Also, the user need not balance the mobile electronic device 12 or try to maintain steadiness of the mobile electronic device 12 as the user takes a photograph of the object to be photographed 24 with the camera 14 of the mobile electronic device 12.

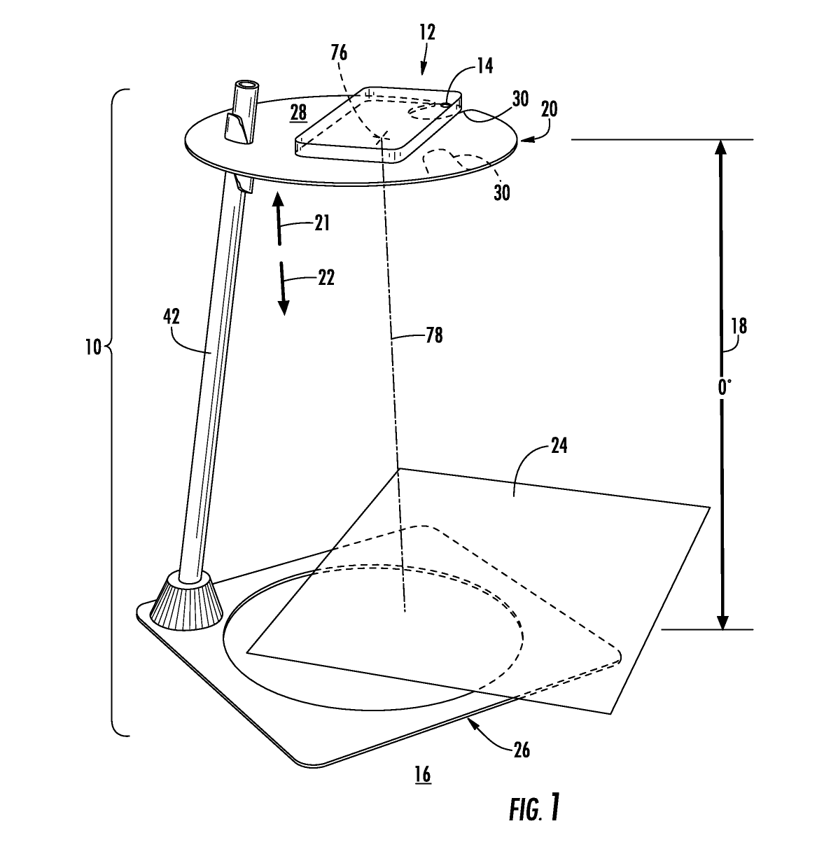

Referring now to FIG. 1, the shelf 20 may have a circular outer periphery and be cut out from a base 26. The shelf 20 may have a flat upper surface 28 supporting the mobile electronic device 12. The upper surface 28 may be textured to provide additional frictional engagement between the mobile electronic device 12 and the upper surface 28 of the shelf 20. The upper surface 28 is shown in FIG. 1 as a flat surface that allows the mobile electronic device 12 to be oriented in any position on the shelf 20. However, it is also contemplated that the upper surface 28 may be sized and configured to fix the orientation of the mobile electronic device 12 so that the mobile electronic device 12 is at a particular orientation on the shelf 20. By way example and not limitation, a center of mass of the mobile electronic device 12 may be aligned to a center of mass of the shelf 20 to prevent lateral tilting or shifting of the shelf 20 on the dowel rod 42 during use. In particular, the upper surface 28 may have a recess or an indent that receives the electronic device 12 or a series of protruding nubs that align the mobile electronic device on the shelf 20. The outer periphery of the shelf 20 may also have an indentation or cutout 30. The camera 14 of the mobile electronic device 12 may be positioned in the indentation 30 to better align the mobile electronic device 12 on the shelf 20 and also to the object 24 being photographed. Although one indention 30 is shown in FIG. 1, the shelf 20 may have additional indentations 30 about the periphery thereof to provide alternate positions of the mobile electronic device 12 on the shelf 20. One or more holes (not shown) may also be formed in the shelf 20 to further provide additional positions of the mobile electronic device 12 to optimally position the camera 14 with respect to the shelf 20 and the object 24 being photographed.

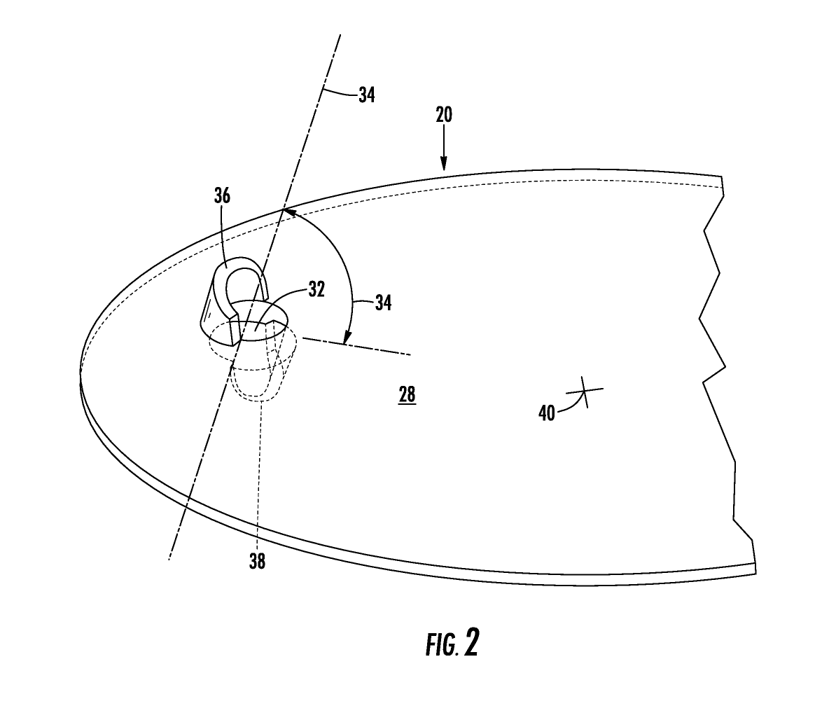

Referring now to FIG. 2, the shelf 20 may also have an angled through hole 32. The angled through hole 32 has a central axis 34 that is skewed with respect to the upper surface 28 of the shelf 20. Preferably, the angle 34 is about 15 degrees to about 25 degrees. The through hole 32 may have or be defined by an upper lip 36 and a lower lip 38. The upper and lower lips 36, 38, are positioned opposite from each other with respect to a flat member that defines a shelf 20 and also with respect to the through hole 32. More particularly, the upper lip may be disposed above the upper surface 28 and be formed at an outer side of the through hole 32. In contrast, the lower lip 38 may be formed below the upper surface 28 of the shelf 20 and formed at an inner side of the through hole 32. The inner and outer sides of the through hole 32 is with respect to a center of mass 40 of the shelf 20. The side of the through hole 32 closer to the center of mass 40 is the inner side, whereas, the side of the through hole 32 further away from the center of mass 40 is the outer side of the through hole 32. These lips together create a sufficiently large contact area between the through hole and the dowel rod for a frictional hold at the leveraged or cantilevered resting position of shelf 20.

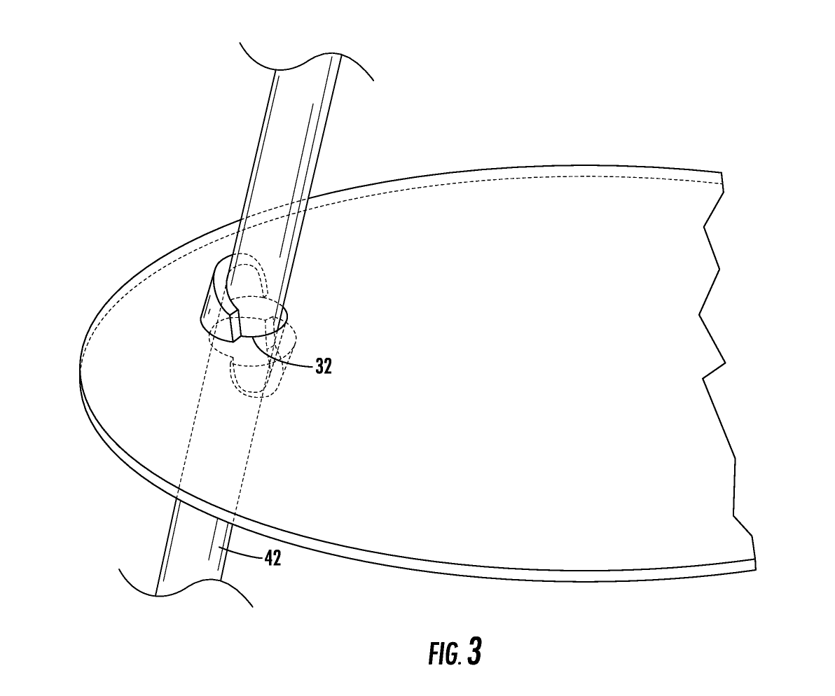

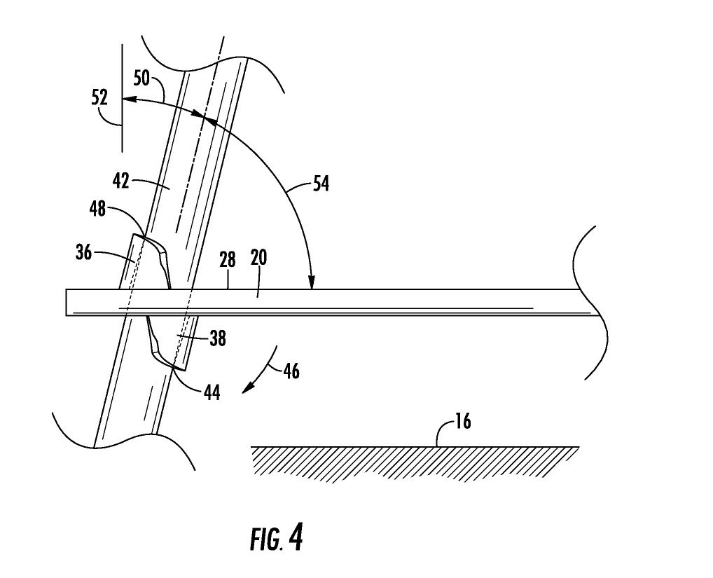

The upper lip and the lower lip 38 may have a semicircular configuration and may circumscribe about fifteen (15) to one-hundred and eighty (180) degrees of the dowel rod 42 that is slidingly received within the angled through hole 32. The dowel rod 42 is shown as being inserted through the angled through hole 32 in FIG. 3. FIG. 4 illustrates a side view of the dowel rod and the shelf 20. FIG. 4 illustrates how the lower lip 38 engages the dowel rod 42. Together, the combination of upper lip 36 and lower lip 38 create enough surface friction to provisionally prevent the shelf 20 from sliding downward. Alternatively, engagement may be mechanical, where the lower lip 38 may have an edge 44 that engages the outer surface of the dowel rod 42. The weight of the shelf 20 and the mobile electronic device 12 when the mobile electronic device 12 rests on the shelf 20 rotates the shelf 20 in the direction of the arrow 44. The rotation 46 and the weight of the shelf 20 may cause an edge 44 to be mechanically engaged into the outer surface of the dowel rod 42 and prevent the shelf from sliding downward Moreover, the edge 44 may be sharpened to further aid in mechanically engaging the exterior surface of the dowel rod 42. The upper lip 36 may also have an edge 48. The edge 48 and the exterior surface of the dowel rod 42 may be sized and configured to also be mechanically engaged to each other to further prevent the shelf 20 from sliding downward on the dowel rod 42 by the weight of the shelf 20. However, the engagement mechanism may exclusively be surface friction. By way of example and not limitation, the exterior surface of the dowel rod 42 may be coated with a polymeric frictional material, roughened such as by sand blasting or treated in other ways known in the art or developed in the future for increasing the coefficient of friction. To this end, the edge 48 of the upper lip 36 and the exterior surface of the dowel rod 42 may be treated to further increase frictional engagement there between. By way of example and not limitation, friction material may be coated on the edge 48 and the exterior surface of the dowel rod 42 or may be roughened. Although the through hole 32 has been described as being defined by a simple hole or the upper and lower lips 36, 38, other configurations are also contemplated. By way of example and not limitation, the through hole 32 may have a different configuration depending on the type of material used (e.g., wood, polycarbonate, plastic, etc.) and even on the fabricating process (e.g., milling, injection molding, etc.).

The dowel rod 42 may be held at a particular angle 50 with respect to a gravitational direction which defines a vertical line 52. The angle 50 and the engagement between the upper and lower lips 36, 38 with the dowel rod 42 may be configured so that the shelf 20, and more particularly, the upper surface 28 of the shelf is preferably horizontal or parallel (i.e., angle) 18=0° with the support surface 16. The angular correction for horizontal is accomplished at the hinged connection in the anchored base. However, it is also contemplated that the upper surface 28 may have different skewed angles with respect to the support surface 16 by changing the angle 50 and the engagement between the upper and lower lips 36, 38 with the dowel rod 42 in order to alter the angle 54 between the dowel rod 42 and the shelf 20. This skewed angle is also modified or affected by adjusting the hinge position at the anchored base.

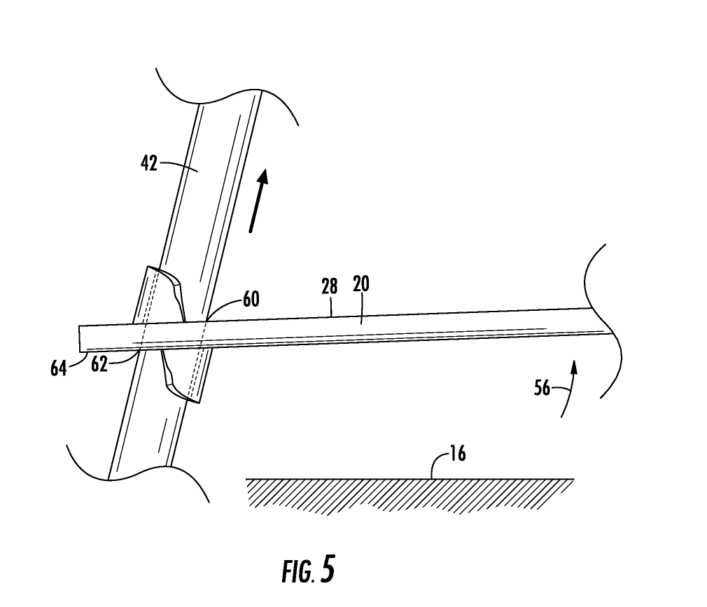

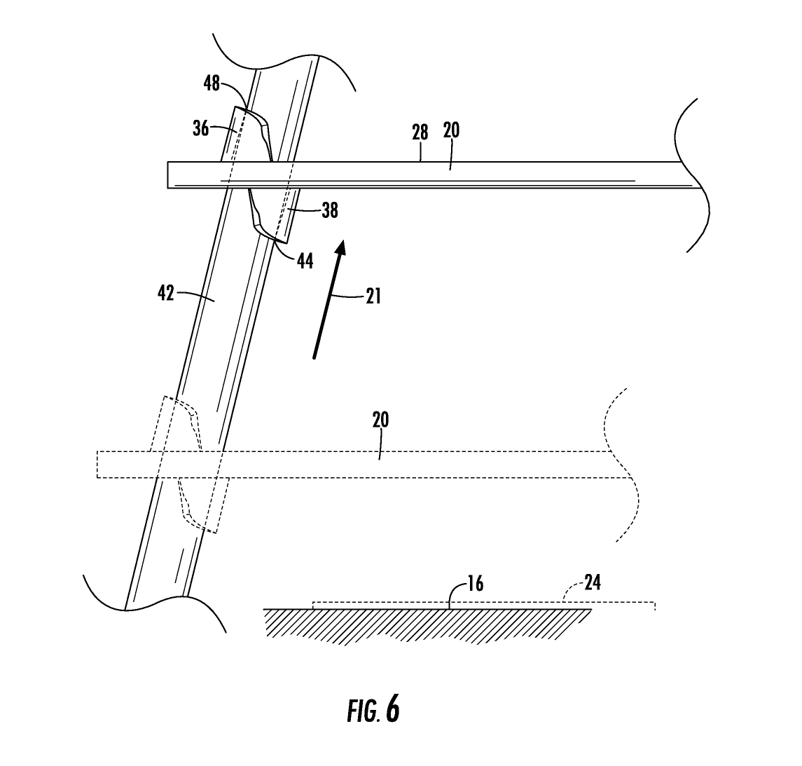

Referring now to FIGS. 5 and 6, the shelf 20 is shown as being moved upward 21 along the dowel rod 42 to move the mobile electronic device 12 further away from the object 24 being imaged or photographed. To this end, the shelf 20 is lifted up or rotated in the opposite direction from the angular rotation 46 as shown by arrow 56 to loosen its frictional hold due to gravity. The through hole 32 is sized larger than the dowel rod 42 to allow sliding when not gravitationally engaged in the leveraged or cantilevered position. When shelf 20 returns to rest in the cantilevered position, frictional engagement gets reestablished and holds the shelf 20 in position. The dowel rod 42 may be straight so that the upper surface 28 remains the same with respect to the support surface 16. However, the dowel rod 42 may flex or bend or curve, but angle 50 may be readjusted at the hinge to compensate. Alternatively, the dowel rod 42 may be curved so that the shelf 20 and the target object 24 may have a different angular relationship depending on the vertical position of the shelf 20 on the dowel rod 42.

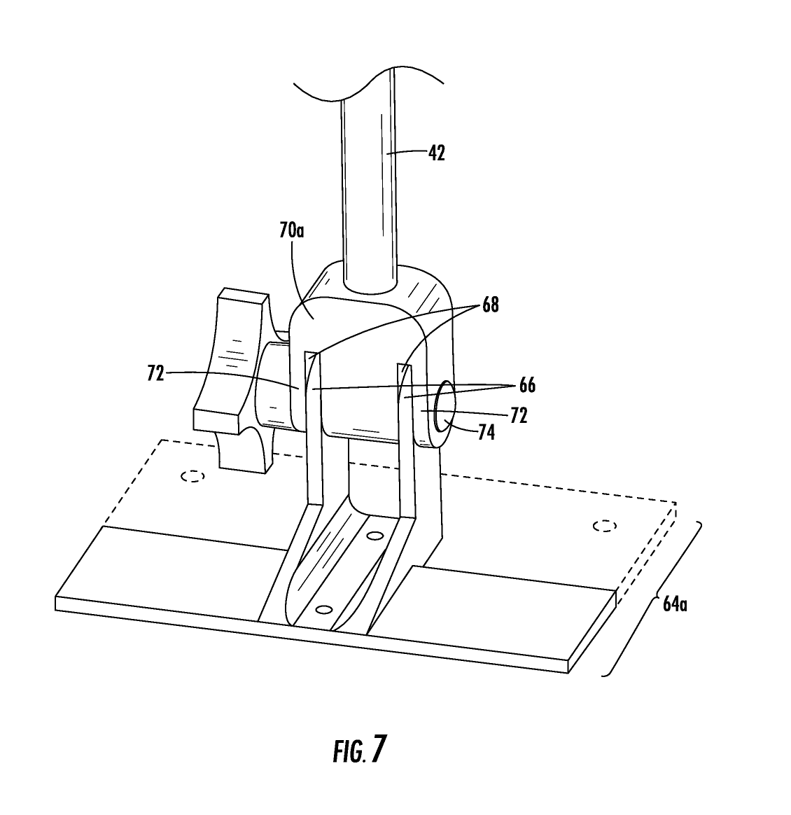

The dowel rod 42 may have a fixed relationship to the support surface 16, as shown in FIG. 1 or may be adjustable, as shown with respect to FIGS. 7-10. In FIG. 1, the dowel rod 42 is fixedly attached to the base 26. The base 26 is an enlarged flat rigid member which cannot pivot with respect to the dowel rod 42 at its lower distal end. By way of example and not limitation, the attachment may be made by welding, bolting, adhesion or other known methods known in the art or developed in the future.

Referring now to FIG. 7-10, methods and apparatuses of adjusting the angle 50 of the dowel rod 42 are shown. More particularly, referring now to FIG. 7, the base may be a mounting member 64a for securing the stand 10 to the support surface 16. The mounting member 64a may have a hinge assembly that makes use of contact surfaces for static friction. This hinge assembly may be comprised of two or more prongs 66 that are inserted into two or more slots 68 which belong to a mating mounting member 70a.

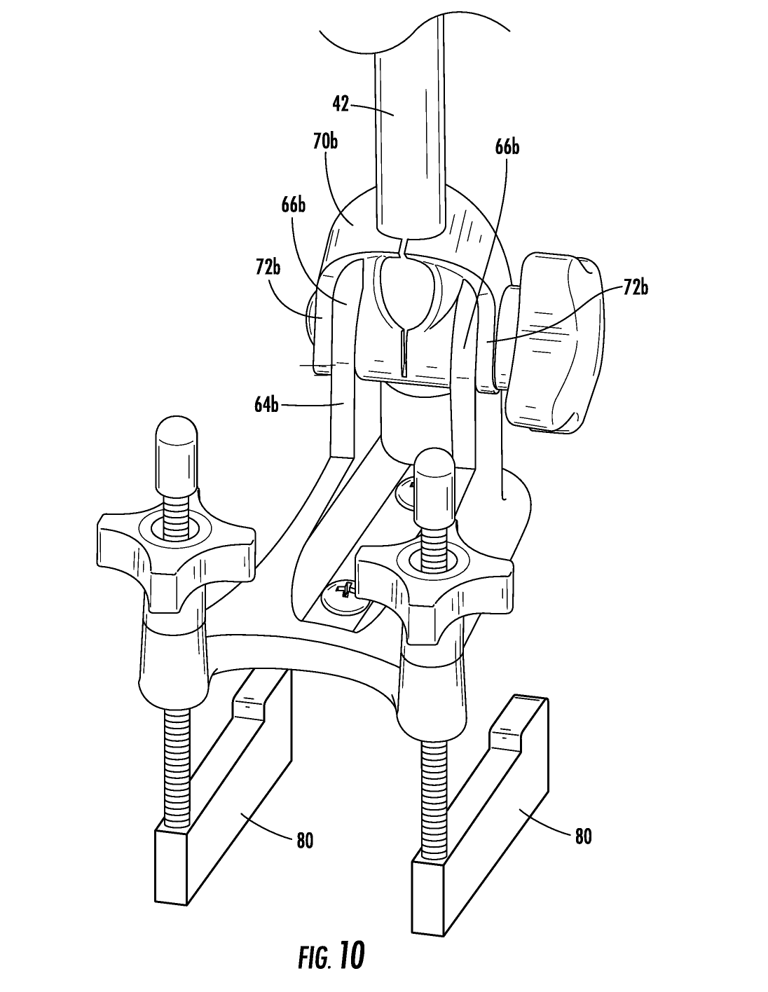

The multiple prongs of a hinge assembly 70a, 64a may have matching surface areas of contact to create static friction to restrict hinge movement. The movement or axial position of the assembled hinge 70a, 64a may be adjusted by adjusting the axial compression of an axle bolt 74 that is inserted through all prongs. Axial compression of the axle bolt may be accomplished by the turning of hand knobs or levers that preclude the use of separate tools. The prongs or plates and their matching slots may be of same or different thickness and may be separately attached to the dowel rod 42 or integrally formed with the dowel rod 42 and with base 64a. The total surface area of contact between the surfaces may be increased by enlarging the prongs and/or by adding more prongs 72, 66 to the mating mounting member 70a to create a sufficient amount of friction so that the angle between the base and the dowel rod can be manually set to correct for horizontal, to compensate for load deflection of shelf 20, or to compensate for free play of the upper components that result in unanticipated or unwanted angle 50. The static friction force may also be adjusted by selecting different materials for the prongs such as medium density fiberboard wood, acrylic, acrylonitrile butadiene styrene, aluminum, and polycarbonate. The hinge assembly may be comprised of two or more prongs at the distal end of the dowel rod 42 that are inserted into two or more slots which belong to a mating mounting member 64a. This is not shown in FIG. 7 but is the upside-down or reverse variation. FIG. 10 illustrates a similar construction in that prongs 72b of the mating mounting member 70b are compressed onto prongs 66b of the mounting member 64b. The dowel rod 42 is fixedly secured to the mating mounting member 70a, b.

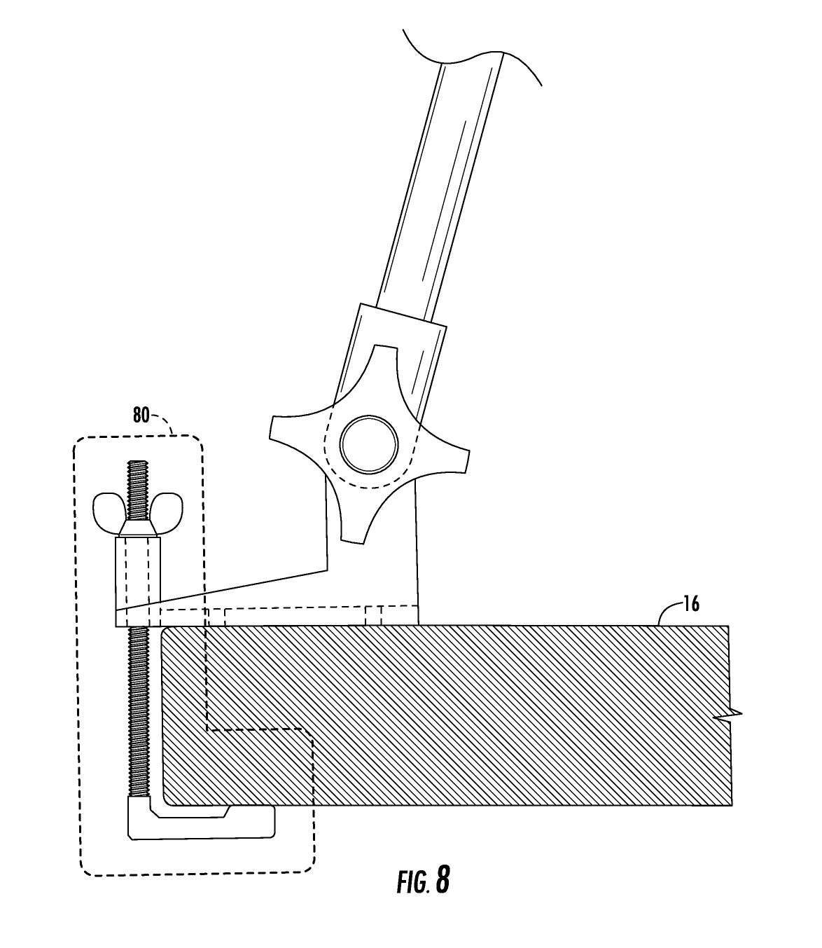

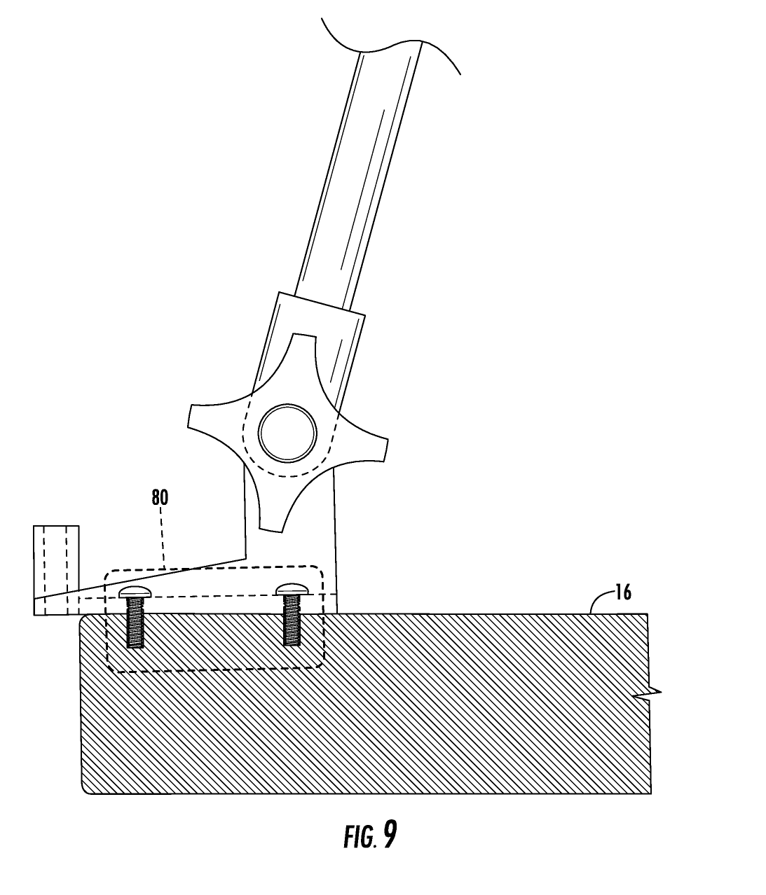

In FIG. 1, the stand 10 is a free-standing appliance sitting on the support surface 16. FIGS. 8 and 9 show alternate means of attaching the stand 10 to the support surface 16. In FIG. 8, the base may be a clamping system 80. In FIG. 9, the base may be a bolting system 82.

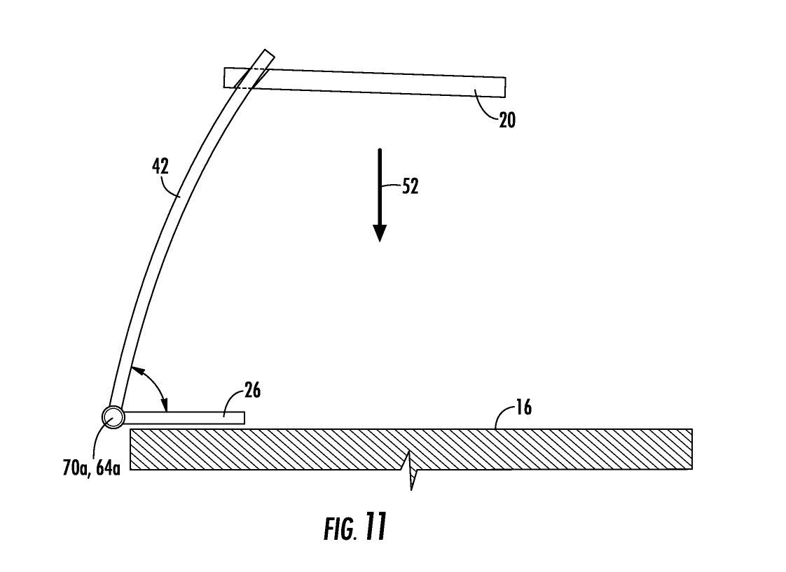

As discussed above, the dowel rod 42 was described as being straight and the shelf 20 as being horizontally level. However, all materials bend when placed under a load. Since the dowel rod 42 is not aligned vertically upward with a gravitational direction 52. The dowel rod 42 is in a sense cantilevered outward and such orientation may cause some bend in the dowel rod 42, as shown in FIG. 11. Such bend in the dowel rod 42 may cause the camera of the electronic mobile device to be misaligned to the support surface or the object being photographed. Additionally, the shelf 20 extends outward and may bend downward either due to its own weight and the weight of the mobile electronic device. To account for any misalignment, the user may adjust the angle of the dowel rod 42 with respect to the support surface as described herein in relation to FIGS. 7-10 (i.e., angularly adjustable hinge 70a, 64a) in order to align the camera of the electronic mobile device to the target object being photographed. The angle of the dowel rod 42 may have an infinite adjustment.

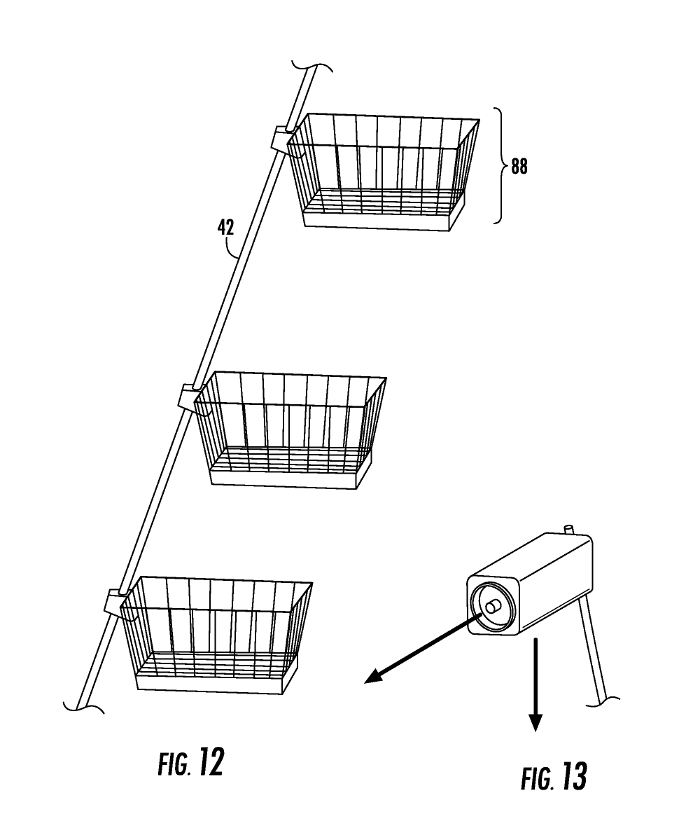

Referring now to FIG. 12, the stand 10 may be used in other applications. By way of example and not limitation, the shelf 20 may be replaced with a basket 88 that can be positioned at one or more positions along the dowel rod 42. Other components such as a laser device may also be adjustably positioned on the dowel rod 42 as shown in FIG. 13. Other applications may include a visual display, illumination device, or whimsical toy. Additionally, when the stand 10 is configured as shown in FIGS. 1-10, the stand 10 can be used to convert your smartphone into a macro camera, scan paper documents, attach a special lens to the smartphone and turn the camera of the smartphone into a microscope, scan checks for mobile deposits and digitize printed photos.

The above description is given by way of example, and not limitation. Given the above disclosure, one skilled in the art could devise variations that are within the scope and spirit of the invention disclosed herein, including various ways of forming the base of the stand. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A stand for holding a mobile electronic device with a camera above a support surface at a particular angle and height to the support surface, the stand comprising:
a shelf capable of holding the mobile electronic device with its built-in camera pointed downward, the shelf having an angled through hole formed away from a center of mass of the shelf, the space below the camera lens rendered clear and unobstructed;
a dowel rod slidably extending through the angled through hole, the dowel rod frictionally engaged to the angled through hole when the dowel rod is skewed with respect to a vertical axis and the shelf pivots about the angled through hole so that opposed interior surfaces of the angled through hole frictionally engage the dowel rod to prevent downward sliding of the shelf on the dowel rod;
a base attached to the dowel rod below the shelf, the base being sufficient to hold the dowel rod and the shelf in a stationary position with respect to the support surface.

2. The stand of claim 1 wherein the base is a hinged anchor that can adjust the angle of the dowel rod, thereby adjusting the level of the associated shelf.

3. The stand of claim 1 wherein the base and the dowel rod are fixedly attached to each other at a skewed angle so that an upper surface of the shelf upon which the mobile electronic device rests during use is parallel to the support surface.

4. The stand of claim 1 wherein the base is located away from the area directly below the supported mobile electronic device.

5. The stand of claim 1 wherein the base is a flat rigid member that extends below the shelf and an object to be photographed may be placed over the flat rigid member during use.

6. The stand of claim 1 wherein the base is a mounting member that is boltable to the support surface or clampable to the support surface.

7. The stand of claim 1 wherein the shelf has a cut out at a periphery or interior of the shelf to accommodate a camera lens of the mobile electronic device.

8. The stand of claim 1 wherein the dowel rod has a round exterior surface and the angled through hole has a corresponding round interior surface, an inner diameter of the angled through hole being greater than an outer diameter of the dowel rod.

9. The stand of claim 1 wherein the dowel rod has a round, square, triangular, polygonal cross sectional configuration.

10. The stand of claim 1 wherein the angled through hole is formed with an upper lip extending upward at an outer upper edge of the through hole and a lower lip extending downward at an inner lower edge of the through hole.

11. The stand of claim 1 wherein the angled through hole is formed by a hole slightly larger than the dowel rod and located at a reinforced portion of the shelf.

12. The stand of claim 1 wherein all positional settings and adjustments are achieved by hand manipulations without the use of separate tools.

13. A method of operating a camera stand of a mobile electronic device above a support surface to adjust for height and angle of the mobile electronic device and the support surface, the method comprising:
placing the mobile electronic device on an upper surface of a shelf of the camera stand;
lifting a shelf of the camera stand upward to disengage frictional engagement between a through hole of the shelf and a dowel rod;
traversing the shelf up or down the dowel rod;
tilting the shelf of the camera stand downward to engage frictional engagement between the through hole of the shelf and the dowel rod.
adjusting an angle of the dowel rod to compensate for off level displacement due to a weighted shelf.

14. The method of claim 13 wherein the placing step includes the step of engaging the mobile electronic device with a nub or recess formed in the upper surface of the shelf to fix a position of the camera on the shelf.

15. The method of claim 13 wherein the lifting step includes the step of releasing an edge of a lower lip of the shelf with the dowel rod.

16. The method of claim 15 wherein the lifting step further includes the step of releasing an edge of an upper lip of the shelf with the dowel rod.

17. The method of claim 13 wherein the tilting step further comprises the step of releasing the shelf to allow gravity to tilt the shelf downward.

18. The method of claim 13 wherein the adjusting step includes the step of releasing a hinge for free movement and tightening the hinge to restrict angular rotation of the hinge to a fixed position.

19. The method of claim 13 wherein the angular adjustment of the shelf includes side-to-side yaw rotation about the dowel rod axis.

20. A stand for adjusting vertical placement of an object above a support surface, the stand comprising:
a dowel rod set at a skewed angle with respect to a vertical gravitational direction;
a mounting bracket having a through hole, the through hole being sufficiently larger than the dowel rod so that the mounting bracket is freely traversable up and down the dowel rod by hand, a lower interior edge of the through hole of the mounting bracket frictionally engagable to an outer surface of the dowel rod to fix a position of the mounting bracket on the dowel rod;
an object attached to the mounting bracket;
a base anchor and/or a head anchor for the dowel rod;
wherein the through hole of the mounting bracket has a central axis generally coaxially aligned to a central axis of the dowel rod when the mounting bracket is freely traversable up and down the dowel rod, the object being properly aligned when the lower interior edge of the through hole of the mounting bracket is frictionally engaged to the exterior surface of the dowel rod.

21. The stand of claim 20 wherein the through hole of the mounting bracket is defined by an upper lip disposed on an exterior side of the through hole and a lower lip disposed on an interior side of the through hole.

22. The stand of claim 20 wherein the through hole of the mounting bracket is defined by a hole slightly larger than the dowel rod and located at a reinforced portion of the mounting bracket.

23. The stand of claim 20 wherein the dowel rod is fixedly attached at opposed upper and lower distal end portions of the dowel rod to a first support surface at the upper distal end portion of the dowel rod and to a second support surface at the lower distal end portion of the dowel rod.

24. The stand of claim 20 wherein the base anchor of the dowel rod incorporates a hinge.

25. The base anchor of claim 24 wherein the hinge provides for angular adjustment and is adjustable by hand.

26. The hinge of claim 25 wherein hand tightening of the hinge is sufficient to set the dowel rod at a desired angle.

27. The stand of claim 20 wherein the object is a basket, camera, visual display, illumination device or whimsical toy.
